(19) United States
(12) Patent Application Publication
(10) Pub. No.: US 2009/0248397 A1
(43) Pub. Date: Oct. 1, 2009

(54) Service Initiation Techniques

(75) Inventors: Jonathan Garcia, Duvall, WA (US); Jane T. Kim, Seattle, WA (US); Robert E. Dewar, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/055,291

(22) Filed: Mar. 25, 2008

(51) Int. Cl. G06F 17/27; G10L 11/00

(52) U.S. Cl. 704/9; 704/275; 704/E11.001

(57) ABSTRACT

Service initiation techniques are described. In at least one implementation, a computing device receives a selection of text that is displayed in a user interface by an application. Selection is detected of one of a plurality of services that are displayed in the user interface. Responsive to the detection, the selection of text is provided to the selected service without further user intervention.

### BACKGROUND

Services may be configured to provide a wide variety of functionality that may be of interest to a user. For example, services may be used to provide directions to a desired restaurant, to find a definition for a particular word, to locate a weather forecast for a favorite vacation spot, and so on. Traditional techniques that were utilized to access these services, however, were often cumbersome and hindered user interaction. Therefore, users often chose to forgo interaction with the services, which also had adverse financial ramifications to providers of the services.

### SUMMARY

Service initiation techniques are described. In at least one implementation, a computing device receives a selection of text that is displayed in a user interface by an application. Selection is detected of one of a plurality of services that are displayed in the user interface. Responsive to the detection, the selection of text is provided to the selected service without further user intervention to initiate operation of the selected service using the selection of text.

In an implementation, one or more computer-readable media include instructions that are executable to determine which of a plurality of services are to receive text that is displayed in a user interface by an application based on a speech input. The instructions are also executable to provide the text to the determined service without user intervention.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The same numbers are used throughout the drawings to reference like features.

FIG. 1 illustrates a system in which various principles described herein can be employed in accordance with one or more embodiments.

FIG. 2 illustrates a system having a multi-layered service platform in accordance with one or more embodiments.

FIG. 3 illustrates an example system having a multi-layered service platform in accordance with one or more embodiments.

FIG. 4 illustrates a user interface in accordance with one or more embodiments.

FIG. 5 illustrates a user interface in accordance with one or more embodiments.

FIG. 6 illustrates a user interface in accordance with one or more embodiments.

FIG. 7 illustrates a user interface in accordance with one or more embodiments.

FIG. 8 illustrates a user interface in accordance with one or more embodiments.

FIG. 9 illustrates a user interface in accordance with one or more embodiments.

FIG. 10 illustrates a user interface in accordance with one or more embodiments.

FIG. 11 illustrates a user interface in accordance with one or more embodiments.

FIG. 12 illustrates a user interface in accordance with one or more embodiments.

FIG. 13 illustrates a user interface in accordance with one or more embodiments.

FIG. 14 illustrates a user interface in accordance with one or more embodiments.

FIG. 15 illustrates a user interface in accordance with one or more embodiments.

FIG. 16 is a flow diagram that describes steps in a method in accordance with one or more embodiments.

FIG. 17 is a flow diagram that describes steps in a method in accordance with one or more embodiments.

FIG. 18 is a flow diagram that describes steps in a method in accordance with one or more embodiments.

FIG. 19 illustrates an example system that can be used to implement one or more embodiments.

### DETAILED DESCRIPTION

### Overview

Although services may be utilized to provide a wide variety of functionality as previously described, traditional techniques used to initiate interaction with the services were cumbersome. For example, a user may view an output of text from an application, such as an address of a restaurant received in an email and viewed using an email application. If the user desires directions to restaurant, the user may interact with a mapping service. However, to get those directions, the user selects the text in the email that contains the address and copies the text, such as by right-clicking a mouse to display a menu having a copy command or using a “ctrl-c” key combination.

Once copied, the user typically opens a browser and navigates to a web site which provides a web service having mapping functionality, e.g., to provide turn-by-turn directions. Once “at” the web site, the user may then paste the text (or retype it in another example), and then press “enter” to receive the desired directions. Thus, as shown in this example the user traditionally manually switched contexts (e.g., from the email application to the browser application), which may be disruptive, as well as engaged in a lengthy and often cumbersome process to interact with the service.

Service initiation techniques are described. In an implementation, selection of a service is used to provide text to a service to initiate an operation of the service using the text. Following the previous example, the user may select text in the email which contains the address of the restaurant. The user may then press a hot key and speak, click or touch a representation of a desired service, which in this example is a name of the mapping service. The selected texted is then provided to the service to generate the directions without further user interaction. Thus, the user may “select and ask” to initiate operation of the service. In an implementation, preview functionality may also be used such that a result of operation of the service using the text is displayed without switching contexts, further discussion of which may be found in relation to the following sections.

In the discussion that follows, a section entitled “Operating Environment” is provided and describes one environment in which one or more embodiments can be employed. Following this, a section entitled “Example Multi-layered Service Platform” is provided and describes a multi-layered platform in accordance with one or more embodiments. The multi-layered structure includes, in at least some embodiments, a global integration layer that is designed to integrate services with legacy applications, as well as a common control integration layer and a custom integration layer. The common control integration layer can be used to provide a common control that can be used across applications to integrate not only services of which the applications are aware, but services of which the applications are not aware. The custom integration layer can be used by various applications to customize user interfaces that are designed to integrate various offered services.

Next, a section entitled “Implementation Example” describes an example implementation of a multi-layered service platform. Following this, sections entitled “Global Integration Layer—User Interface Example”, “Common Control Integration Layer—User Interface Example”, and “Custom Integration Layer—User Interface Example” each respectively provide examples of user interfaces in accordance with one or more embodiments. Next, a section entitled “Example Procedures” describes example procedures in accordance with one or more embodiments. Finally, a section entitled “Example System” describes an example system that can be utilized to implemented one or more embodiments.

### Operating Environment

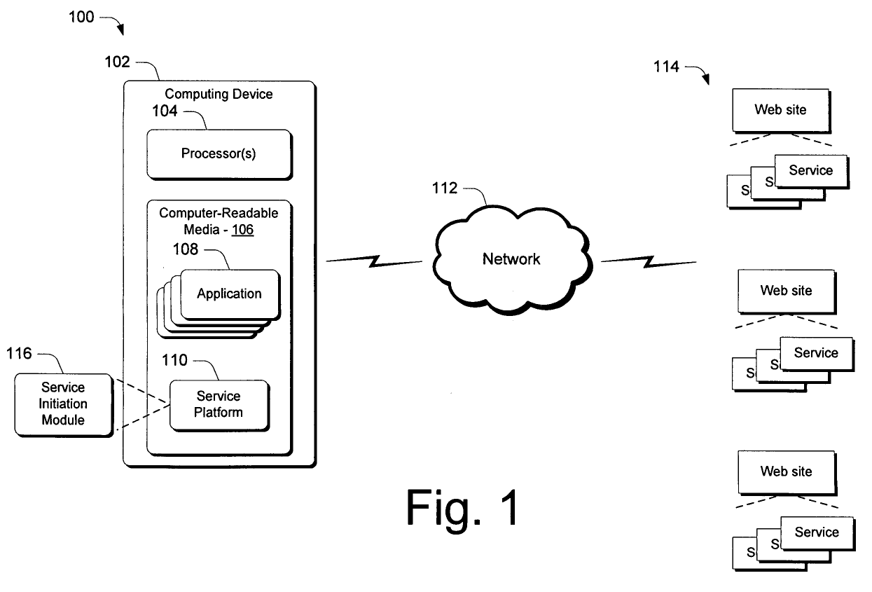

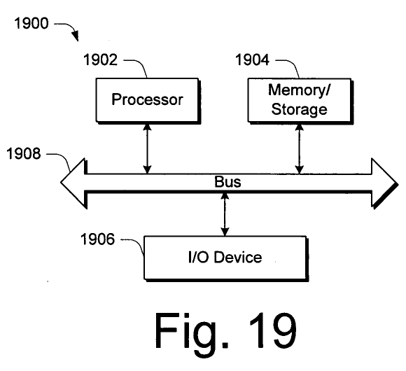

FIG. 1 illustrates an operating environment in accordance with one or more embodiments, generally at 100. Environment 100 includes a computing device 102 having one or more processors 104, one or more computer-readable media 106 and one or more applications 108 that reside on the computer-readable media and which are executable by the processor(s). Applications 108 can include any suitable type of application such as, by way of example and not limitation, browser applications, reader applications, email applications, instant messaging applications, and a variety of other applications. The computer-readable media can include, by way of example and not limitation, a variety of forms of volatile and non-volatile memory and/or storage media that are typically associated with a computing device. Such media can include ROM, RAM, flash memory, hard disk, removable media and the like. One specific example of a computing device is shown and described below in FIG. 19.

In addition, computing device 102 includes a service platform 110. In an implementation, the service platform may integrate services, such as web services (e.g., services accessible over a network 112 from one or more websites 114) and/or local services, across a variety of applications such as those mentioned above and others. In at least some embodiments, services can be integrated with legacy applications that are “unaware” of such services, as well as applications that are aware of such services as will become apparent below. As indicated in the figure, the service platform 110 resides in the form of computer-readable instructions or code that resides on computer-readable media 106.

The service platform 110 may be configured in a variety of ways. As illustrated in FIG. 1, for instance, the service platform 110 is illustrated as including a service initiation module 116 that is representative of functionality to initiate operation of a service. For example, the service initiation module 116 may be incorporated as a part of an operating system that includes copy functionality, e.g., a “clipboard” that is accessible via a hot key combination “CTRL C”. Using this functionality, the service initiation module 116 may receive text that was output by one or more of the applications 108. A variety of other examples of text selection is also contemplated, such as “drag and drop” and so on. Further, although this example described use of functionality incorporated within an operating system to copy text, other examples are also contemplated such as through configuration of the service initiation module 116 as a “stand alone” module, incorporation within one or more of the applications 108, and so on.

The service initiation module 116 is also representative of functionality to select a particular service that is to perform an operation using the selected text. Service selection may be performed in a variety of ways. For example, the service initiation module 116 may leverage voice recognition techniques and therefore accept a speech input. The voice recognition techniques may be incorporated within the service initiation module 116, within an operating system executed on the computing device 102, as a stand-alone module, and so on. The service initiation module 116 may also accept touch inputs, traditional mouse/keyboard inputs, and so on to select a particular service.

The service initiation module 116 is further representative of techniques to initiate operation of the selected service using the selected text. For example, once the particular service is selected, the service initiation module 116 may provide the selected text (e.g., from the “clipboard”) to the particular service without further user interaction, e.g., without having the user manually “paste” the text into the service after selection of the service. Thus, the service initiation module 116 may provide efficient access to services, further discussion of which may be found in relation to the following sections.

Computing device 102 can be embodied as any suitable computing device such as, by way of example and not limitation, a desktop computer, a portable computer, a handheld computer such as a personal digital assistant (PDA), cell phone, and the like.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices, e.g., the computer-readable media 106. The features of the service initiation techniques described below are platform-independent, meaning that the techniques may be implemented on a variety of commercial computing platforms having a variety of processors.

### Example Multi-Layered Service Platform

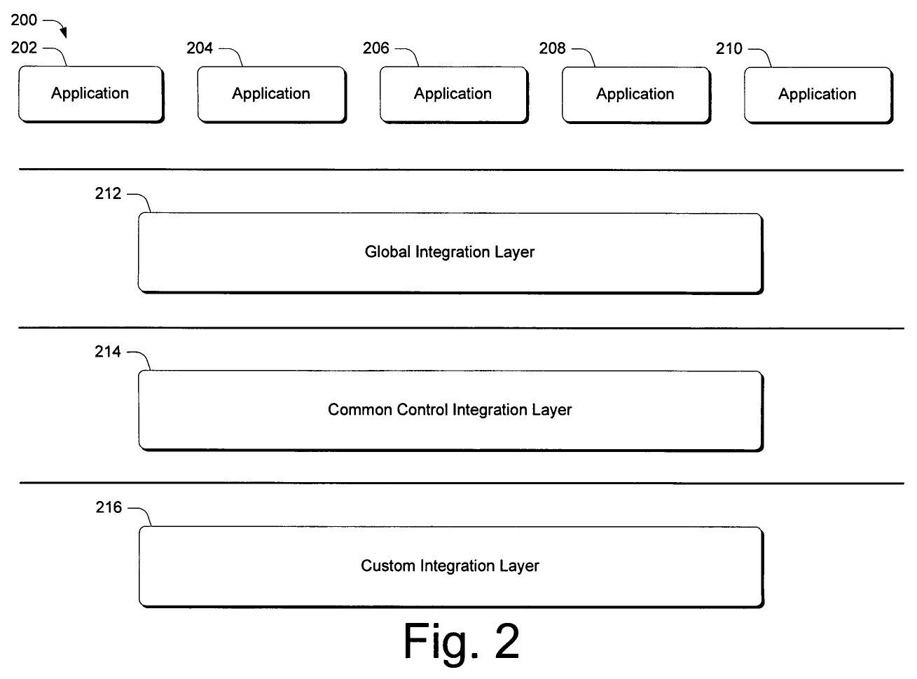

FIG. 2 illustrates a system having a multi-layered service platform in accordance with one or more embodiments, generally at 200. In this example, system 200 includes multiple different applications 202, 204, 206, 208, and 210. The applications can comprise a variety of applications examples of which are provided above and below. In addition, system 200 includes, in this example, multiple different platform layers that are designed to integrate services, both web services and/or local services, across a variety of applications such as applications 202-210. In this particular example, the multiple different layers include a global integration layer 212, a common control integration layer 214, and a custom integration layer 216.

In the illustrated and described embodiment, the global integration layer 212 is designed to enable applications that are not “service aware” to nonetheless allow a user to access and use such services from within the applications. To this end, in at least some embodiments, the global integration layer provides a generic user interface that displays one or more services that are available and which can be invoked from within an application. In this embodiment, functionality of the global integration layer is supported by an operating system operating on a local client device.

When a user wishes to ascertain which services are available from within an application that is not service aware, the user can take a particular action, such as using a shortcut on the operating system desktop (e.g. keying a hot key combination) which is detected by the operating system. Responsive to detecting the user action, the operating system can make an API call to a local service store to receive a listing of services that are available. The operating system can then present a generic user interface that lists the available services for the user.

In one or more embodiments, once the generic user interface has been presented to the user, the user can take a number of different actions. For example, in some embodiments, the user can hover their cursor over a particular service description or icon and receive a preview of that service. Alternately or additionally, a user can click on a particular service description or icon and then be navigated to that service's functionality. Further, the user may provide a speech input by speaking a name or other identifier that is suitable to select a particular service from a plurality of services. Navigation to a particular service's functionality can include a local navigation or a web-based navigation. In one or more embodiments, navigation can include sending data, such as that selected by a user, to the service for operation by the service.

Thus, in this embodiment, the generic user interface that is provided by the operating system is knowledgeable of the particular API calls that are used to present available services and to enable users to select one or more of the services. In this manner, applications that are not “service aware” can still be used as a starting point for a user to access services.

In the illustrated and described embodiment, the common control integration layer 214 provides a control that can be hosted by one or more applications. The control can allow applications to populate those services that the applications natively support, as well as to provide a means by which services which are not natively supported by the applications can nonetheless be offered to a user.

When a user wishes to ascertain which services are available from within an application, the user can take a particular action such as making a particular selection, such as a text selection or file selection. Responsive to detecting the user action, the hosted control can make an API call to a local service store to receive a listing of services that are available. The control can then present a user interface that lists the available services for the user. These services can include services that are offered by the application natively, as well as services that are offered by other service providers either locally or remotely.

In one or more embodiments, once the user interface has been presented to the user, the user can take a number of different actions. For example, a user may select one of the services using speech, such as by speaking an identifier (e.g., a name and/or action performed by a service such as “map it” for a mapping service) of a particular one of the services to select the service, a customized identifier previously input by the user to select the user, and so on.

In some embodiments, the user may request a “preview” of a particular service, e.g., through a speech input (e.g., “preview map”), can “hover” a cursor over a particular service description or icon, and so on. Alternately or additionally, a user can then select (e.g., click on) a particular service description or icon and then be navigated to that service's functionality. Navigation to a particular service's functionality can include a local navigation or a web-based navigation.

Thus, in this embodiment, the control is knowledgeable of the particular API calls that are used to present available services and to enable users to select one or more of the services. In this manner, applications can use the control to both offer services natively and provide services offered by other service providers. In addition, as the control can be hosted by many different applications, a common user experience can be provided across a variety of applications.

In one or more embodiments, the custom integration layer 216 provides a set of APIs that can be used by applications that are aware of the APIs to receive a list of offered services and then create their own user interface and user experience through which a user can consume the offered services.

Having described the general notion of a multi-layered service platform, consider now an implementation example that describes one specific instance of a multi-layered service platform. It is to be appreciated and understood that the following description provides but one example, and is not to be used to limit application of the claimed subject matter to a specific implementation. Accordingly, other implementations can be utilized without departing from the spirit and scope of the claimed subject matter.

### Implementation Example

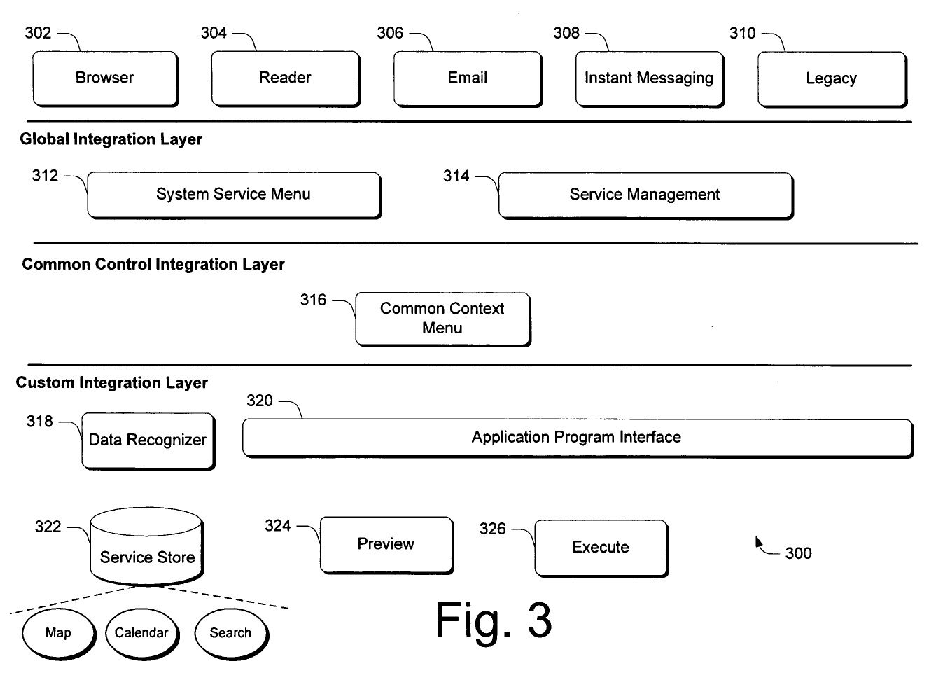

FIG. 3 illustrates an example system having a multi-layered service platform in accordance with one or more embodiments, generally at 300. In this example, system 300 includes applications in the form of a Web browser 302, a reader application 304, an email application 306, an instant messaging application 308, and one or more so-called legacy applications 310. In the context of this document, a legacy application can be considered as an application that is not aware of at least some of the services that a user can access while using the application. The illustrated applications are provided for example and are not intended to limit application of the claimed subject matter. Accordingly, other applications can be used without departing from the spirit and scope of the claimed subject matter.

In this particular example, a global integration layer includes a system service menu 312 and a service management component 314, and a common control integration layer includes a common context menu 316. Further, in one or more embodiments, a custom integration layer includes a data recognizer component 318, an application program interface or API 320, a service store 322, a preview component 324, and an execute component 326.

In one or more embodiments, the system service menu 312 of the global integration layer can be invoked by a user while using one or more applications and with context provided by the application(s). In practice, applications that are not “service aware” can be used to invoke the system service menu. In one or more embodiments, the system service menu is supported by the client device's operating system and can be invoked in a variety of ways. For example, selection of text displayed by an application may cause output of the system service menu 312 as a pop-up menu next to the selected text.

In another example, in at least some embodiments, a user can access the system service menu by keying in a particular hot key combination. Once detected by the operating system, the hot key combination results in an API call to application program interface 320 to receive a list of available services. The available services can be services that are offered locally and/or services that are offered by remote service providers. System service menu 312 then presents a user interface that lists the available services that can be accessed by the user. In one or more embodiments, the user interface presented by the system service menu 312 is generic across a variety of applications, thus offering an integrated, unified user experience.

Once the services are listed for the user via the user interface presented by the system service menu 312, the user may choose a particular service, e.g., by speaking an identifier of a service (e.g., displayed name in a menu, previously stored custom identifier, and so on), using a cursor control device to select the service, and so forth. In one or more embodiments, a user can receive a preview of a service, via a preview component 324 by taking some action with respect to a displayed service.

For example, a user may provide a speech input to initiate the preview of a particular service using text (e.g., “preview definition” for a definition of selected text by a service), hover a cursor over or near a particular description or icon associated with the service and receive the preview of that service, and so on. In one or more embodiments, previews can be provided for the user without having the user leave the context of the application. When the cursor is hovered in this manner, for instance, the operating system can make an API call to the preview component 324 to receive information or data that is to be presented as part of the preview. Alternately or additionally, by clicking on a particular service description or icon, a user can cause the service to execute. When this happens, the operating system can make an API call to the execute component 326 which, in turn, can cause the service to execute. Execution of the service can include, by way of example and not limitation, a navigation activity which can be either or both of a local navigation or a remote navigation. Examples of how this can be done are provided below.

In one or more embodiments, service management component 314 provides various management functionalities associated with services. For example, in one or more embodiments, the service management component 314 can provide functionality that enables a user to add, delete, and/or update the particular service. Further, in one or more embodiments, the service management component can enable a user to set a particular service as a default service for easy access. In yet further embodiments, the service management component 314 may allow a user to customize how text and/or services are selected, e.g., to use custom identifiers for the services that may be spoken by a user to initiate the service.

In one or more embodiments, the common context menu 316 of the common control integration layer provides a common context menu across a variety of applications. In one or more embodiments, the common context menu is a control that can be hosted by a variety of applications. In at least some embodiments, these applications do not have to natively understand how a service or associated activity works. Yet, by hosting the control, the application can still offer the service as part of the application experience.

When an application hosts the common context menu, the application can populate the menu with services it offers, as well as other services that are offered by other service providers. As such, an application can offer both native services as well as non-native services. Further, these services may be local to the computing device 102 (e.g., desktop search) and/or accessible via the network 112, such as web services and other network services. In one or more embodiments, the common context menu is knowledgeable of the application program interface 320 and can make appropriate API calls to receive information on services that are offered and described in service store 322. Specifically, in one or more embodiments, the common context menu is aware of the particular service API.

In one or more embodiments, data recognizer 318 is configured to recognize data associated with particular API calls in which service listings are requested. Accordingly, the data recognizer 318 can then ensure that a proper set of services are returned to the caller. For example, if a user selects a particular portion of text, such as an address, then a particular subset of services may be inappropriate to return. In this case, the data recognizer 318 can see to it that a correct listing of services is returned.

In one or more embodiments, application program interface 320 provides a set of APIs that can be used to add, delete, or otherwise manage services that can be presented to the user. The APIs can include those that are used to receive a listing of services. But one example of the set of APIs is provided below in a section entitled “Example APIs”.

In one or more embodiments, service store 322 is utilized to maintain information and/or data associated with different services that can be offered. Services can be flexibly added and deleted from the service store. This can be done in a variety of ways. In one or more embodiments, this can be done through the use of a declarative model that service providers use to describe the services that are offered. When a call is received by the application program interface 320, information associated with the call can be retrieved from the service store 322 and presented accordingly.

In one or more embodiments, the preview component 324 can be utilized to provide a preview of one or more offered services. An example of how this can be done is provided below.

In one or more embodiments, the execute component 326 can be utilized to execute one or more of the services that are offered. An example of how this can be done is provided below.

### Global Integration Layer—User Interface Example

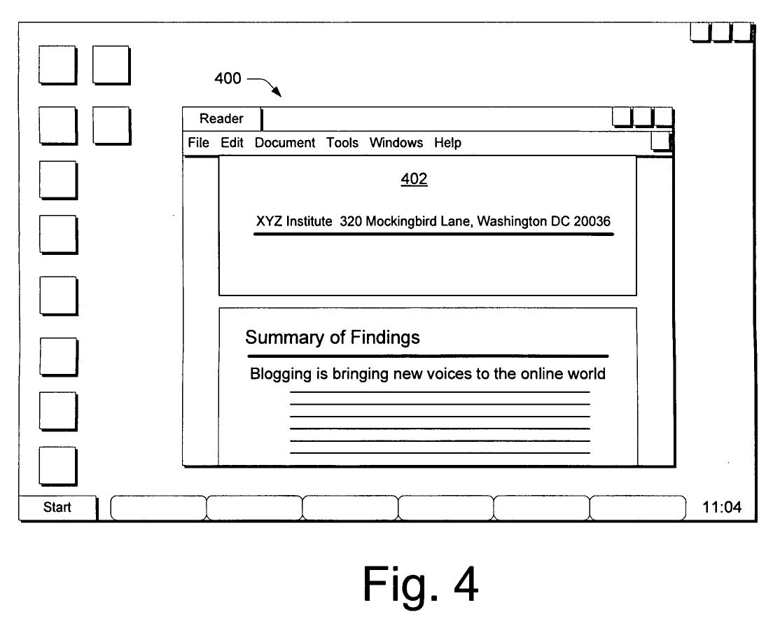

FIG. 4 illustrates a user interface for a reader application generally at 400. In this example, a user has opened the reader application on their desktop and has opened, using the reader application, a document 402. In this example, the reader application does not natively support one or more services that are to be offered to the user.

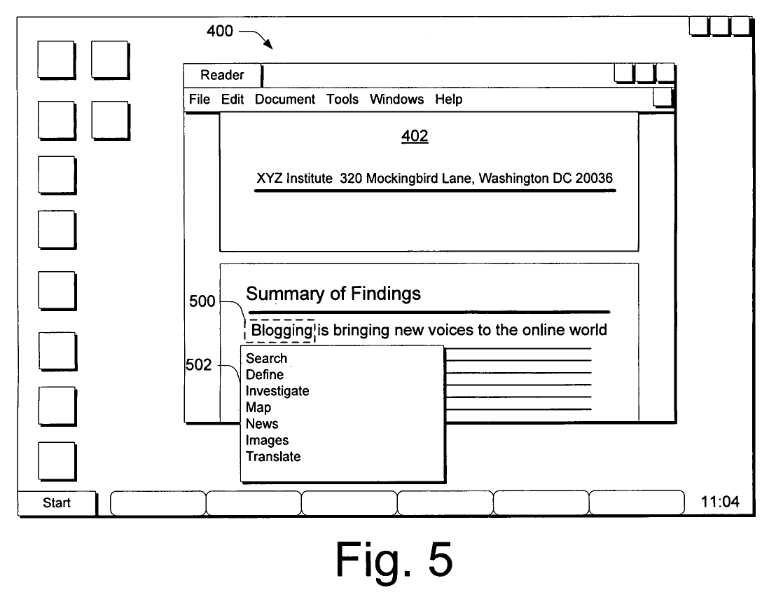

Referring to FIG. 5, the user has selected the text “Blogging” with their cursor, indicated by the dashed box at 500. Responsive to this user action, the operating system has made an API call to application program interface 320 (FIG. 3) and responsively, presents a system service menu 502 which lists a number of available services. As shown, the services include by way of example and not limitation, a search service, a define service, an investigate service, a map service, a news service, an images service, and a translate service. In the illustrated and described embodiment, none of the listed services are natively supported by the reader application 400.

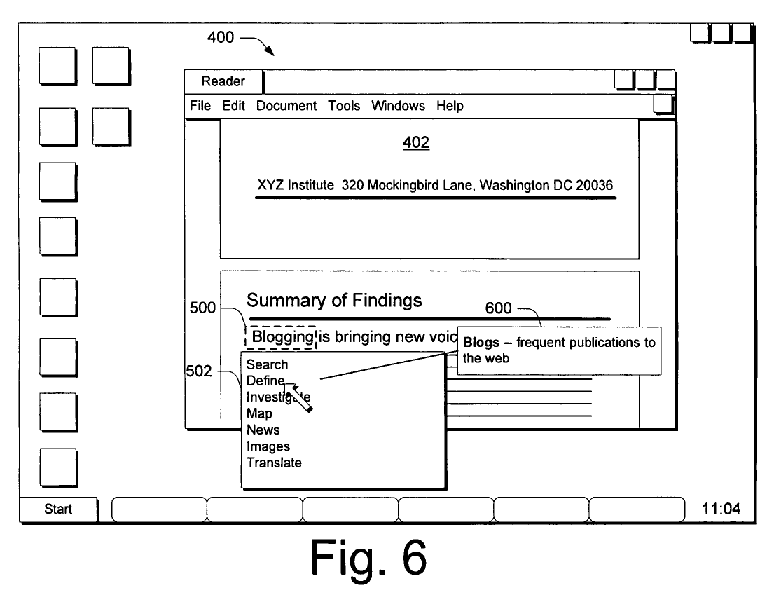

Referring to FIG. 6, a preview 600 is presented for the user. For example, a user may provide a speech input initiating the preview (e.g., “preview define”), may hover a cursor over or near the define service listing, and so on. In this particular example, the preview briefly defines the term that has been selected by the user. In this example, presentation of preview 600 is a result of an API call made by the operating system to the application program interface 320 (FIG. 3) in cooperation with preview component 324 without user intervention that includes the selected text, e.g., “blogging”. In this particular example, the presented preview causes navigation to a remote service provider which, in turn, provides the information displayed in the preview that is a result of an operation performed by the remote service provider using the text.

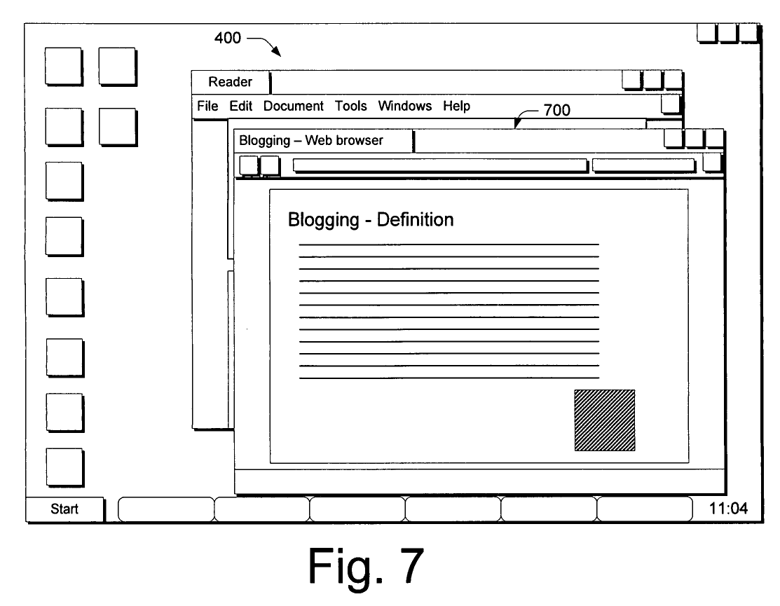

At this point, the user may or may not choose to further execute the service. If the user chooses to execute the service by, for example, clicking on the preview 600, providing a spoken identifier of the service, and so on, a full navigation to a definition site can take place. For example, FIG. 7 illustrates a user interface 700 that is provided as a result of the navigation to a definition site. In this example, a full definition of the term selected by the user can be provided as well as other information provided by the definition site.

In this manner, an application that does not natively support a particular service can, nonetheless, through the support of the operating system, provide access to a number of services. Further, this access may be provided in an efficient manner through spoken word or other inputs that may be used to provide selected text displayed by an application to a service.

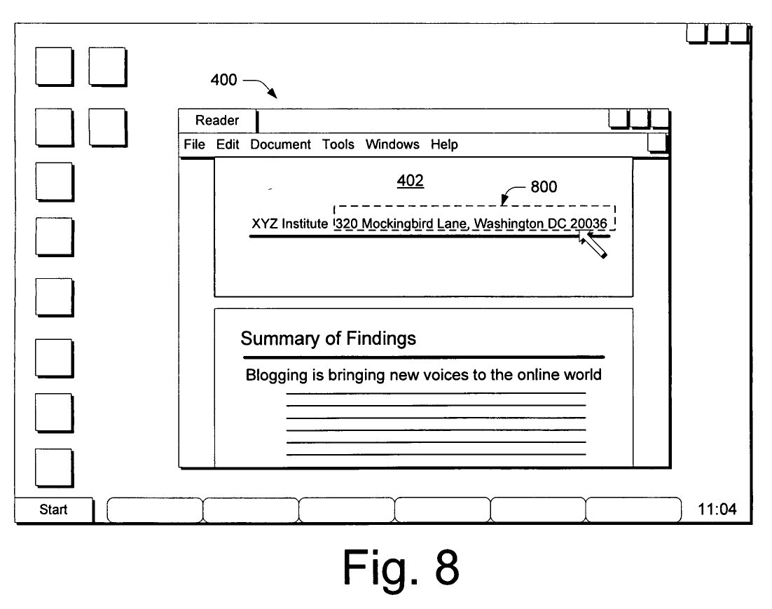

As another example, consider FIG. 8. There, the reader application 400 and document 402 are shown. In this example, the user has selected, with a cursor, an address indicated by the dashed box at 800.

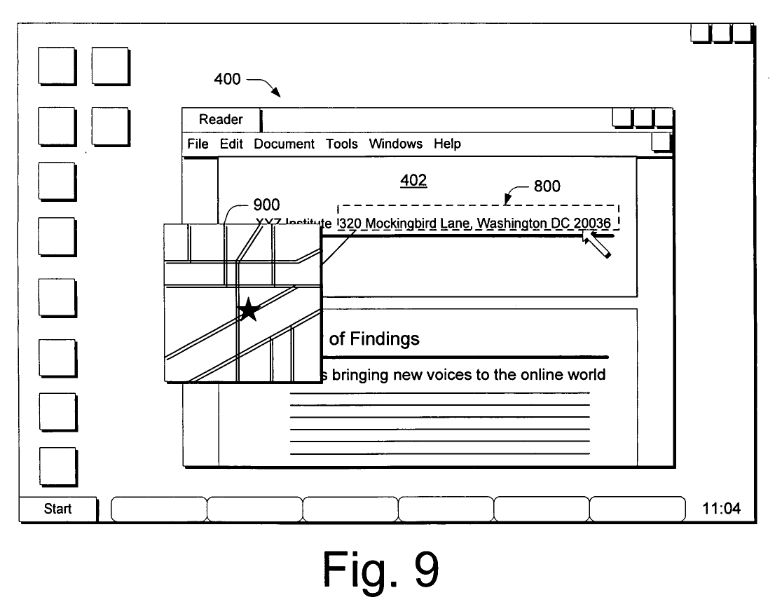

Referring to FIG. 9, a preview in the form of a map user interface 900 has been presented to the user. By clicking on the preview, the user can be navigated to a map site that can, for example, provide the user with an option to receive driving directions to the particular address, as well as other functionality that is commonly provided at map sites.

Again, in this instance, a reader application that does not natively support a mapping service can nonetheless, through the support of the operating system, provide access to a mapping service.

### Common Control Integration Layer—User Interface Example

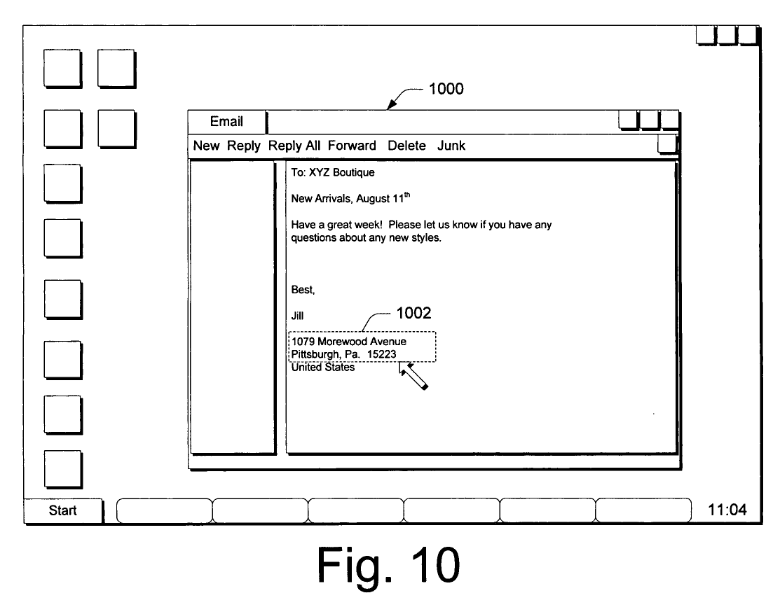

In one or more embodiments, the common control integration layer can provide a common control that can be used by applications to expose services that can be accessed by an application. In one or more embodiments, the common control takes the form of a system service menu such as that provided by system service menu 312 (FIG. 3). As an example, consider FIG. 10 which illustrates a user interface provided by an email application generally at 1000. In this example, the user has selected an address indicated at 1002, such as through use of a cursor control device.

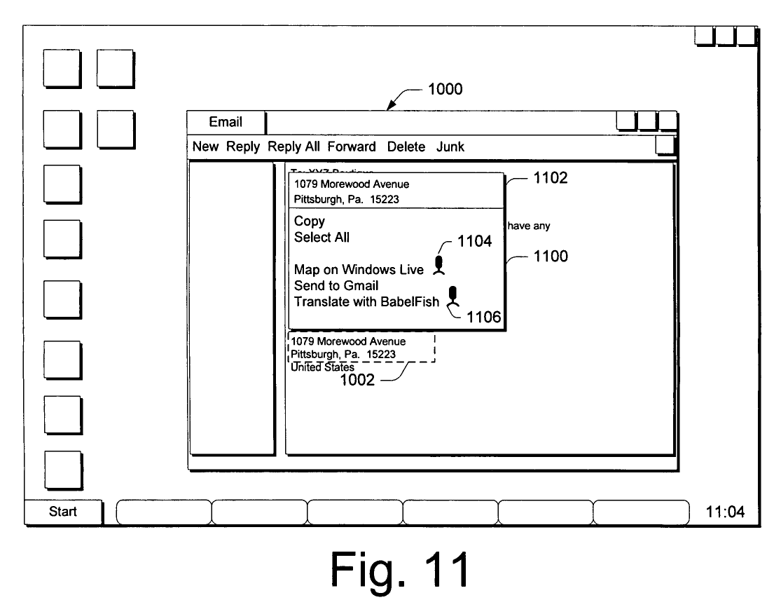

Responsive to the user's selection, a common control can be presented which can display for the user not only services offered by the application, but services that are offered by other service providers. As an example, consider FIG. 11 which illustrates a common control 1100 that lists services offered by the application as well as services that are provided by other service providers. Specifically, in this example, services offered by the application include “Copy” services and “Select All” services.

In addition, other services that are not natively offered by the application can be displayed as well. Specifically, in this example, such services include a “Map on Windows Live” service, a “Send to Gmail” service, and a “Translate with BabelFish” service. In this example, the services that are presented within common control 1100 are the result of an API call that has been made by the control.

The common control 1100 is also illustrated as including a portion having a copy of text (e.g., the address indicated at 1002) that is to be provided to the service to perform a respective operation, e.g., to “Map on Windows Live”. In this way, the common control 1100 may confirm which text will be sent to the service. Further, the common control 1100 is also illustrated as including examples of indications 1104, 1106 that are positioned next to respective representations of services to indicate the represented services are selectable using a speech input.

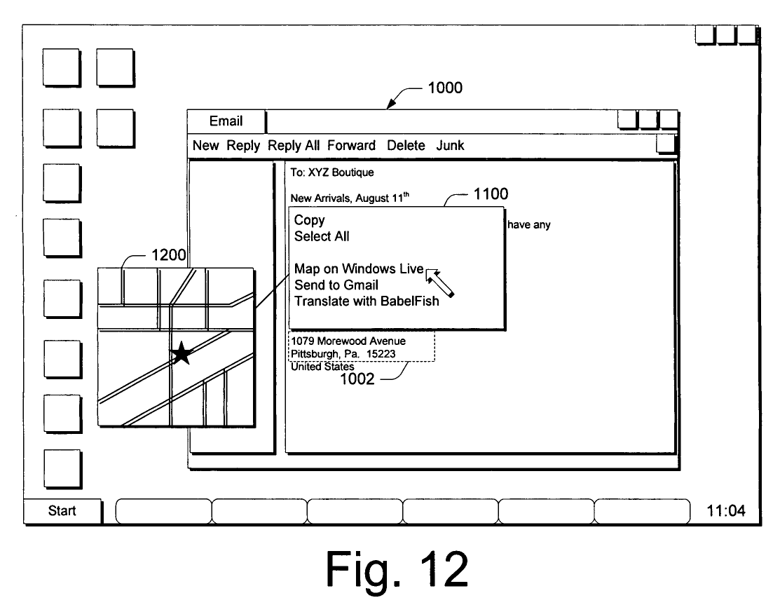

Referring to FIG. 12, a user has hovered a cursor over or near the mapping service and, responsively, has been presented with a map preview 1200 which provides a preview of the service. Now, by clicking on the preview 1200, the user can be navigated to an associated mapping site that provides other mapping functionality as described above. Other selection techniques previously described may also be utilized.

In this manner, a common control can be used across a variety of applications to enable services to be presented to a user that are natively supported by the application as well as those that are not natively supported by the application. Use of a common control across different applications provides a unified, integrated user experience.

### Custom Integration Layer—User Interface Example

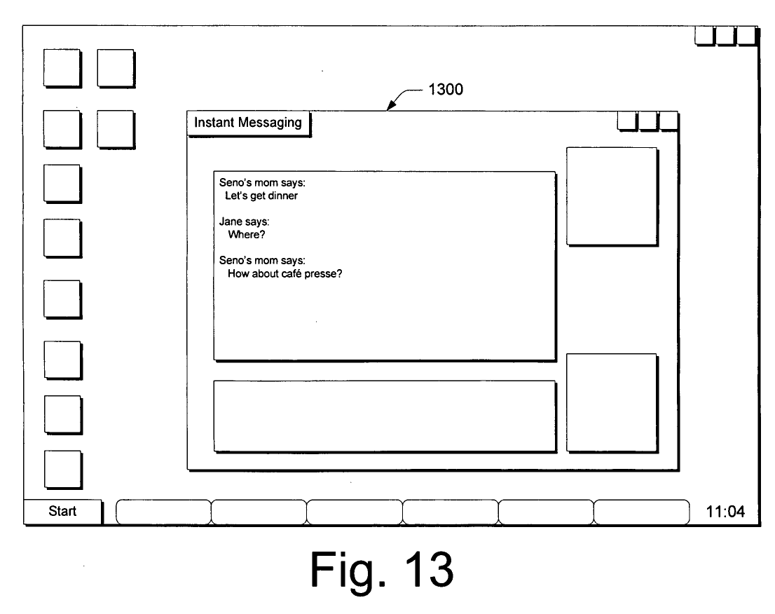

In one or more embodiments, the custom integration layer provides a set of APIs that can be used by applications that are aware of the APIs to receive a list of offered services and then create their own user interface and user experience through which a user can consume the offered services. As an example, consider FIG. 13 which shows an application in the form of an instant messaging application having a user interface 1300. In this example, a user has entered into a dialogue with another person. The dialogue concerns where the participants would like to get dinner. One of the participants has mentioned a particular café.

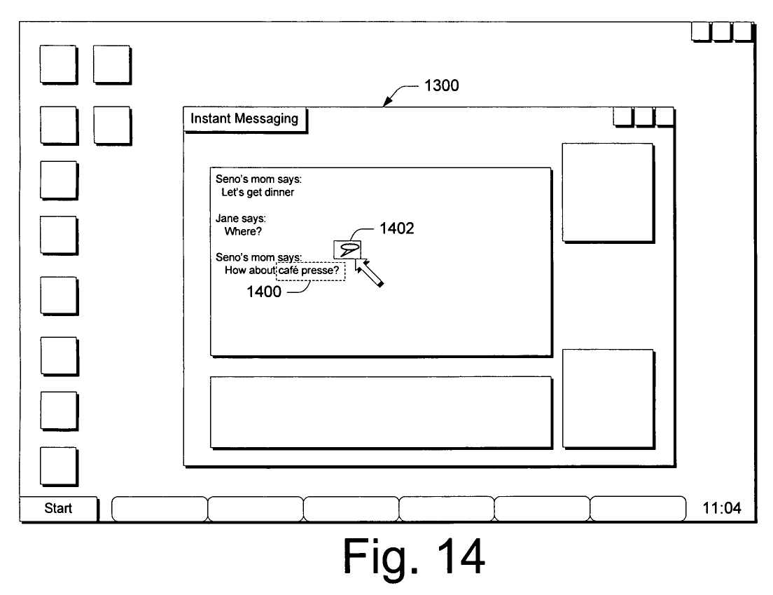

Referring to FIG. 14, the user has selected the text “café presse” as indicated by the dashed box 1400. Responsive to detecting this text selection, the instant messaging application which, in this example, is aware of the platform's APIs, has made an API call to receive back a list of offered services. In this example, a user speaks a command (e.g., “map it”) and a corresponding mapping service is provided and is associated with the icon shown at 1402. In this implementation, the mapping service is provided without further interaction by the user after speaking the command.

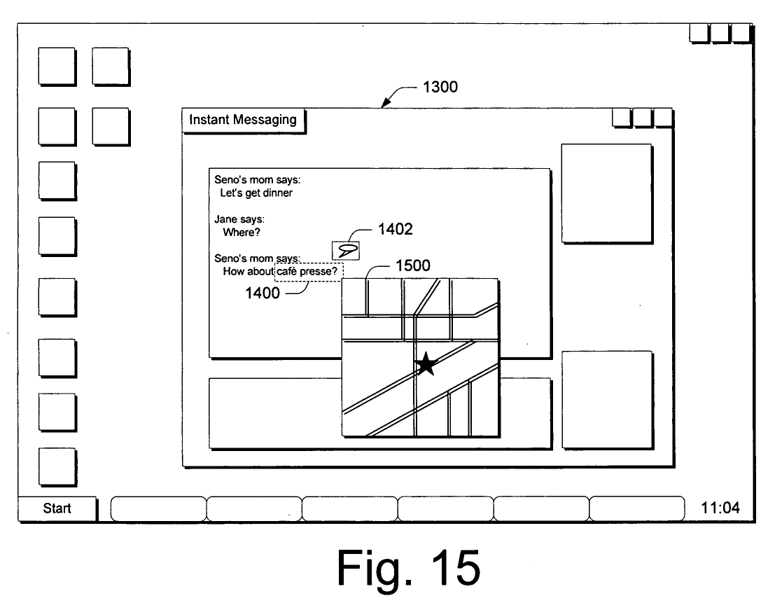

As before, the mapping service may provide a “preview” of an operation performed by the service using the text without navigating the user away from the current user interface. As an example, consider FIG. 15. There, a preview in the form of a map user interface 1500 is provided for the user. The preview may be configured to be selectable such that the user can be navigated to further functionality associated with the map preview. For example, the user can be navigated to a map site that might, for example, provide driving directions associated with the user's particular selection. Further discussion of service selection may be found in relation to the following procedures.

### Example Procedures

The following discussion describes techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the previously described environments and/or user interfaces.

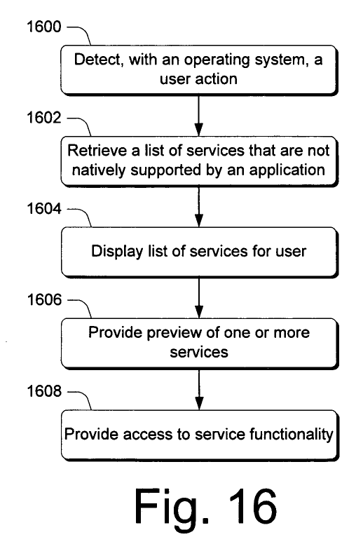

FIG. 16 is a flow diagram that describes steps in a global integration procedure in accordance with one or more embodiments. The procedure can be implemented in connection with any suitable hardware, software, firmware or combination thereof. In at least some embodiments, aspects of the procedure can be implemented by a service platform, such as the one shown and described above.

An operating system detects a user action (block 1600). In the examples above, a user is working within an application such as a legacy application that does not necessarily support services that are desired to be offered. Here, a user action can be one that indicates that the user wishes to learn about and possibly consume one or more services that are not offered by the application. Accordingly, through the user's action, which can constitute any type of action such as a hot key combination, spoken input, and so on, the user can indicate that they wish to learn about offered services. For example, the user may select text, initiate a speech functionality (e.g., press a button) and speak one or more words that may be used to identify a particular one of the services.

The user action is detected by the operating system and, responsively, a list of services is retrieved that are not natively supported by the application (block 1602). The list of services can be retrieved in a variety of ways. In the examples above, the list is retrieved through an operating system call to a platform-supported API.

The list of services for the user (block 1604). This step can be performed in a variety of ways using a variety of user interfaces. A preview is provided of one or more services (block 1606). This step may also be performed in a variety of ways. In the examples above, previews are provided responsive to the user taking some action such as hovering their cursor over or near an icon associated with the service or a description of the service, providing a speech input that is suitable to initiate a preview of a particular one of the services (e.g., “preview definition”), and so on. Access to service functionality is provided (block 1608) which can include, in this example, navigating the user to a remote website where the service functionality is offered. Alternately or additionally, service functionality can be provided locally. It should be readily apparent that the preview is optional and may be skipped upon identification of a particular service, and example of which is described below.

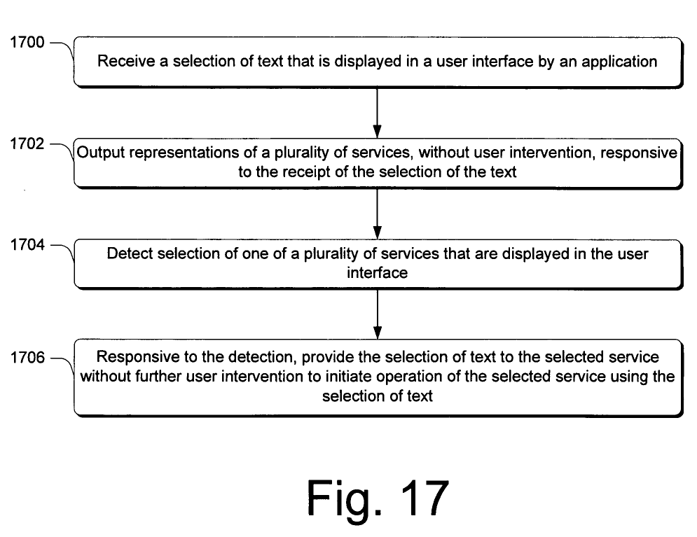

FIG. 17 is a flow diagram that describes steps in a service selection procedure in accordance with one or more embodiments. The procedure can be implemented in connection with any suitable hardware, software, firmware or combination thereof. In at least some embodiments, aspects of the procedure can be implemented by a service platform, such as the one shown and described above.

A selection of text is received that is displayed in a user interface by an application (block 1700). For example, the service initiation module 116 of FIG. 1 may receive text displayed by application 108. The text may be selected in a variety of ways, such as through use of a cursor control device, keyboard, touch screen, speech input, and so on.

Representations of a plurality of services are output, without user intervention, responsive to the receipt of the selection of the text (block 1702). For example, the service initiation module 116 may automatically output representations of the services when the text is selected, which may include services that are not natively supported by the application 108. In another implementation, the representations are output responsive to a command, e.g., a hot key combination, speech input, and so on.

Selection of one of a plurality of services is detected that are displayed in the user interface (block 1704). For example, a user may provide a speech input, “click” or “touch” (e.g., via a touch screen) a representation of a service in a menu. In the speech input example, words used to provide the representation may be spoken (e.g., a name of the service), a name of an operation performed by a service may be spoken (e.g., “map it”), a customized name previously stored by a user of the computing device, and so on. Thus, the service may be selected using a variety of different spoken inputs.

Responsive to the detection, the selection of text is provided to the selected service without further user intervention to initiate operation of the selected service using the selection of text (block 1706). The service initiation module 116, for instance, may navigate to the selected service (e.g., over the network 112 or local to the computing device 102) and paste the content of a clipboard (e.g., text) that was selected. This navigation and pasting of the text may be performed without interaction on the part of the user, and thus may be provided automatically after the selection of the service. A variety of other examples are also contemplated.

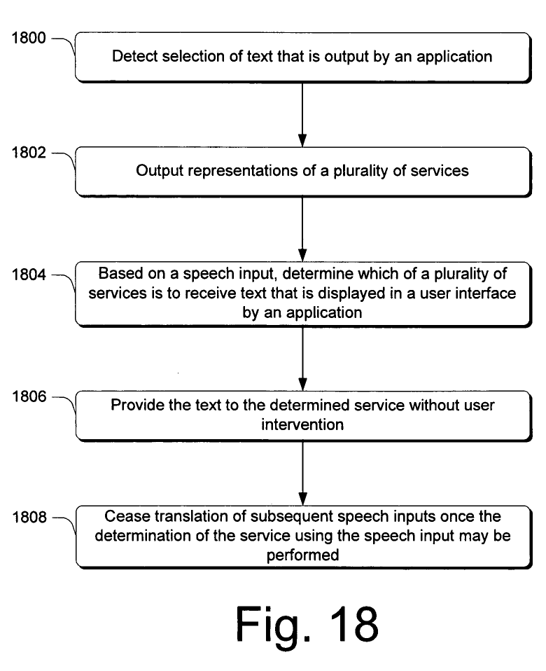

FIG. 18 is a flow diagram that describes steps in a service selection procedure in accordance with one or more embodiments. The procedure can be implemented in connection with any suitable hardware, software, firmware or combination thereof. In at least some embodiments, aspects of the procedure can be implemented by a service platform, such as the one shown and described above.

Selection of text that is output by an application is detected (block 1800), such as by the service initiation module 116 which may be configured as part of an operating system.

Representations are output of a plurality of services (block 1802). For example, a hot key combination, speech input, and so on may be used to initiate an output of a menu having representations of the plurality of services, such as a pop-up menu that is displayed adjacent to the selected text.

Based on a speech input, a determination is made as to which of a plurality of services is to receive text that is displayed in a user interface by an application (block 1804). For example, the user may speak the name of a representation displayed in a menu (e.g., “map” of FIG. 6), may describe an operation performed by a service (e.g., “map address”), may use a customized name previously stored for a service by a user, and so on. In an implementation, the customized speech input may provide a “voice shortcut” to particular services.

The text may then be provided to the determined service without user intervention (block 1806) responsive to the determination. Continuing with the previous example, once a determination is made that a particular service is to be selected, the text may be provided to the service without further interaction on the part of the user with the computing device 102.

In an implementation, translation of subsequent speech inputs may cease once the determination of the service using the speech input may be performed (block 1808). For example, the speech initiation module 116 may “shut off” a microphone used to determine an underlying meaning of a speech input (e.g., determine “what was said”) so as not to further complicate operation of the module, which may conserve resources of the computing device 102.

### Example System

FIG. 19 illustrates an example computing device 1900 that can implement the various embodiments described above. Computing device 1900 can be, for example, computing device 102 of FIG. 1 or any other suitable computing device.

Computing device 1900 includes one or more processors or processing units 1902, one or more memory and/or storage components 1904, one or more input/output (I/O) devices 1906, and a bus 1908 that allows the various components and devices to communicate with one another. Bus 1908 represents one or more of any of several types of bus structures, including a memory bus or memory controller, a peripheral bus, an accelerated graphics port, and a processor or local bus using any of a variety of bus architectures. Bus 1908 can include wired and/or wireless buses.

Memory/storage component 1904 represents one or more computer storage media. Component 1904 can include volatile media (such as random access memory (RAM)) and/or nonvolatile media (such as read only memory (ROM), Flash memory, optical disks, magnetic disks, and so forth). Component 1904 can include fixed media (e.g., RAM, ROM, a fixed hard drive, etc.) as well as removable media (e.g., a Flash memory drive, a removable hard drive, an optical disk, and so forth).

One or more input/output devices 1906 allow a user to enter commands and information to computing device 1900, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. One or more computer-readable media comprising instructions that are executable to:
based on a speech input, determine which of a plurality of services is to receive text that is displayed in a user interface by an application; and
provide the text to the determined service without user intervention.

2. One or more computer-readable media as described in claim 1, wherein the text is selected in the user interface using a cursor control device such that other text in the user interface is not selected and is not provided to the determined service.

3. One or more computer-readable media as described in claim 1, wherein the instructions are further executable to output a user interface containing a representation of each of the plurality of services.

4. One or more computer-readable media as described in claim 3, wherein at least one said representation includes an identifier which indicates that selection of a corresponding said service is performable by providing the speech input.

5. One or more computer-readable media as described in claim 1, wherein the instructions are further executable to preview a result of processing performed by the determined service using the provided text.

6. One or more computer-readable media as described in claim 5, wherein the preview is performed without opening a browser.

7. One or more computer-readable media as described in claim 5, wherein the preview is initiated using speech.

8. One or more computer-readable media as described in claim 1, wherein the speech input corresponds to a name of the determined service.

9. One or more computer-readable media as described in claim 1, wherein the speech input corresponds to a previously-stored customized name given to the determined service by a user.

10. One or more computer-readable media as described in claim 1, wherein the instructions are further executable to cause translation of subsequent speech inputs to cease once the determination of the service using the speech input may be performed.

11. One or more computer-readable media as described in claim 1, wherein the instructions are configured as part of an operating system.

12. One or more computer-readable media as described in claim 1, wherein at least one said service is local to a computing device that executes the instructions.

13. One or more computer-readable media as described in claim 1, wherein at least one said service is remote to a computing device that executes the instructions.

14. One or more computer-readable media as described in claim 1, wherein the instructions are executable to perform the determination for a plurality of said applications to access the plurality of services, at least one of which is local to a computing device that executes the instructions and another one of which is remote to the computing device.

15. One or more computer-readable media as described in claim 1, wherein the instructions are part of a module that is callable by the application via one or more application programming interfaces (APIs) to perform the determination and the provision.

16. One or more computer-readable media comprising instructions that are executable to output a user interface having a plurality of representations of services, at least one of which is accessible via a network, in which, at least one of the representations is selectable via speech to cause selected text to be provided to a respective said service without further user intervention.

17. One or more computer-readable media as described in claim 16, wherein the at least one said representation is output in the user interface with an indication that the representation is selectable using speech.

18. A method implemented by a computing device comprising:
receiving a selection of text that is displayed in a user interface by an application;
detecting a selection of one of a plurality of services that are displayed in the user interface; and
responsive to the detecting, providing the selection of text to the selected service, without further user intervention, to initiate operation of the selected service using the selection of text.

19. A method as described in claim 18, wherein the selection of the one of the plurality of services is performed using a cursor control device.

20. A method as described in claim 18, further comprising outputting representations of each of the plurality of services, without user intervention, responsive to the receiving of the selection of the text.
